(19) United States
(12) Patent Application Publication
(10) Pub. No.: US 2002/0062386 A1
(43) Pub. Date: May 23, 2002

(54) Method and apparatus for improving real time and/or interactive animation over a computer network

(76) Inventors: Christopher Piche, West Vancouver (CA); David E. Marwood, North Vancouver (CA)

Correspondence Address: Bruce M. Green, c/o Oyen Wiggs Green & Mutala, 480 - 601 West Cordova Street, Vancouver, BC, V6B 1G1, CA

(21) Appl. No.: 09/978,082

(22) Filed: Oct. 17, 2001

Related U.S. Application Data
(60) Provisional application No. 60/244,599, filed on Nov. 1, 2000.

(51) Int. Cl. G06F 15/16

(52) U.S. Cl. 709/234; 709/248

(57) ABSTRACT

Over a poor quality network, interactive computer animation displayed at the client terminal may be jittery due delays in processing the animation at the client. The present invention therefore provides a method for improving interactive animation over a computer network having a client and a server, comprising: a) forming a queue of server messages at the client; b) adding received server messages to the queue; c) calculating the minimum deadline of the server messages in the queue; d) calculating the time required to play all the currently queued animations; and e) if the time required to play all the currently queued animations is greater than the minimum deadline of the server messages in the queue, accelerating the animation.

This application claims priority from U.S. Provisional application Ser. No. 60/244,599 filed Nov. 1, 2000.

### TECHNICAL FIELD

The invention relates to the field of computer-rendered animation and interactive communication of animation over a computer network, and more particularly to methods for improving the timing of interactive computer animation over a computer network.

### BACKGROUND ART

Communication of interactive computer animation over a computer network is widespread, particularly over the Internet in the context of interactive and non-interactive animated games or events played or observed by one or more participants at client terminals which interact with a game or other application resident on a server over the Internet. Such animation may correspond both to simulated and actually occurring, real world events. Similarly, two or more clients can interact on a peer-to-peer basis over the Internet.

Typically in such animated applications, the server sets a deadline for the client to render an animation. A server may set such a deadline in a server message in both interactive and non-interactive situations. Several such network messages from the server may be queued in a stack at the client terminal. The client terminal is busy animating earlier messages and may not be able to service the queue. Therefore if time is lost at the client in the queue there is less time for the client to make the necessary decision and the server may move on to the next step in the sequence before receiving the client's response. Consequently, over a poor quality network, for example, the animation displayed at the client terminal may be jittery due to the uneven timing of the arrival of the animation information from the server.

Disclosure of Invention

The present invention therefore provides a method for improving interactive animation over a computer network having a client and a server, comprising: a) forming a queue of server messages at the client; b) adding received server messages to the queue; c) calculating the minimum deadline of the server messages in the queue; d) calculating the time required to play all the currently queued animations; and e) if the time required to play all the currently queued animations is greater than the minimum deadline of the server messages in the queue, accelerating the animation.

The present invention further provides a computer program product for improving interactive animation over a computer network having a client and a server, the computer program product comprising:

a computer usable medium having computer readable program code means embodied in the medium for forming a queue of server messages at the client;

the computer usable medium having computer readable program code means embodied in the medium, adding received server messages to the queue;

the computer usable medium having computer readable program code means embodied in the medium for calculating the minimum deadline of the server messages in the queue;

the computer usable medium having computer readable program code means embodied in the medium for calculating the time required to play all the currently queued animations; and

the computer usable medium having computer readable program code means embodied in the medium for determining if the time required to play all the currently queued animations is greater than the minimum deadline of the server messages in the queue, and if it is, accelerating the animation.

### BRIEF DESCRIPTION OF DRAWINGS

In drawings which disclose a preferred embodiment of the invention:

FIG. 1 is a schematic diagram illustrating a computer network for carrying out the invention; and

FIG. 2 is a flowchart illustrating the method of the invention.

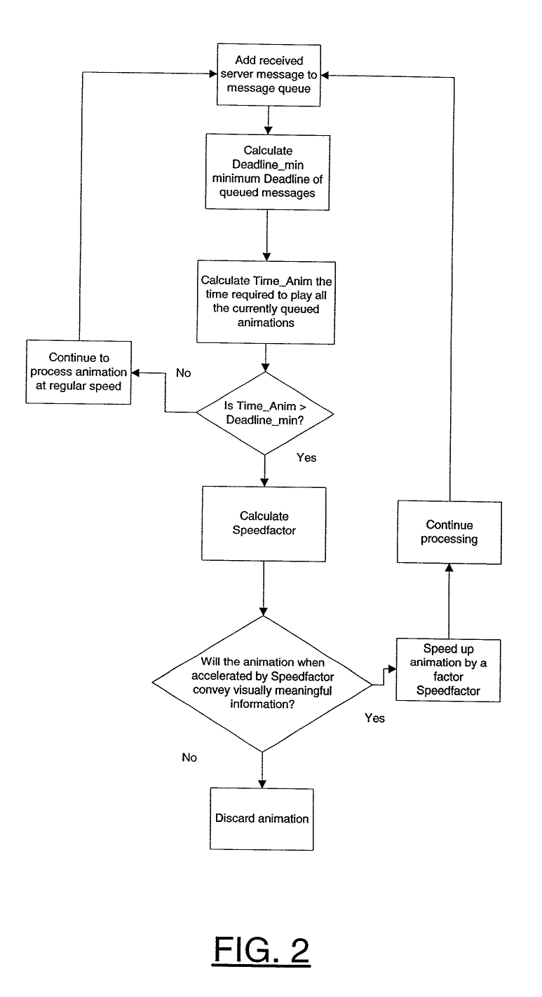

### BEST MODE(S) FOR CARRYING OUT THE INVENTION

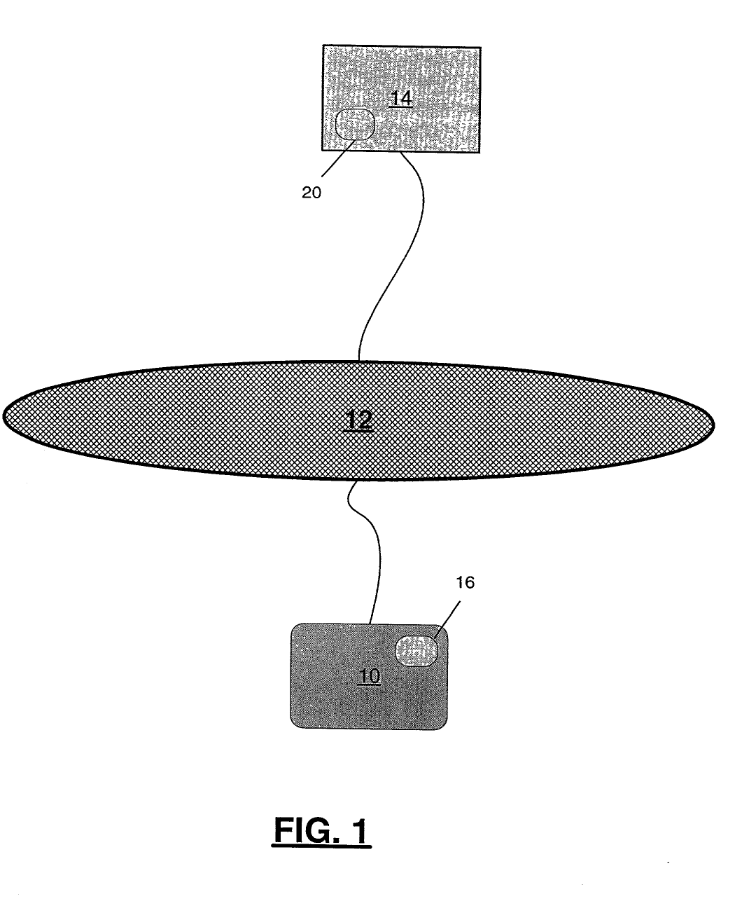

FIG. 1 illustrates schematically a client terminal 10 communicating over a computer network 12 such as the Internet with a server 14. Client terminal has application software 16 which permits it to interact with application software 20 on server 14 which generates, invokes or requests computer animation (the server message may include the animations themselves, or it may invoke or request animations cached at the client). In the process of an interactive application between client 10 and application software 20, several network messages from the server may be queued in the TCP (transmission control protocol) stack at the client terminal. The client terminal 10 is busy processing, that is, animating, the earlier messages and cannot service the queue. The time to move from the end to the front of the queue can become many seconds in the worst situations due to network jitter etc. In interactive situations such as a computer game, the server allows a maximum time for the client to respond and if no response is received within that time the server moves on to the next sequence. Therefore if time is lost at the client in the queue there is less time for the client to make the necessary decision.

The present invention solves the problem by accelerating the animation when the client processing falls behind. The client sets a deadline to start processing a message x seconds after it arrives, where x is determined by the message. If the tightest deadline in the message queue is shorter than the time required to process the queued animations, the animations will be accelerated to complete within the deadline.

For each message received from the server but not yet processed, there is a deadline Deadlineᵢ. The smallest or minimum of these deadlines is Deadline_{Min}. The time required to play the queued animations is Time_{Anim}. The Speedfactor is defined as Time_{Anim}/Deadline_{Min}. Ideally the Speedfactor is unlimited, but due to the limitations on processing speed and what is visually meaningful to an observer, the Speedfactor is limited to some number on the order of 5 or 10 for typical animation applications involving human figures. For example, if a maximum of 5 is chosen for the speed factor to avoid excessive speed of the animation, then if the Speedfactor is greater than 1 then the animation is speeded up by a factor of the lesser of the Speedfactor and 5. The invention will also work if some other maximum speed factor is used, or if no maximum is imposed. If the Speedfactor is not greater than 1, then the animations will complete at their normal pace.

The present invention therefore adds a server message queue to the application at the client. All messages from the server are queued there before they are acted upon. A network thread or process is added that reads from the network and queues messages. The new network thread determines each message deadline, Deadlineᵢ, by examining each command in the queue and the deadline at which each message may be processed, and calculates the smallest or minimum of the server message deadlines, Deadline_{Min}. The network thread also calculates Time_{Anim}, the time required to play the currently queued animations at a normal rate, and calculates the Speedfactor, Time_{Anim}/Deadline_{Min}. The new network thread also manipulates the Graphics object to speed animation playback.

Thus, where the time required to play the queued animations is greater than the shortest deadline for responding to a server message, the network thread applies a speed factor to the animation by which the animation playback should be increased, which is preferably the ratio of the current time required to play the queued animations to that shortest deadline. The increase in the animation playback speed may be achieved, for example, by re-interpolation, or other well-known methods. In extreme cases where the acceleration of the animation would result in animation that does not convey visually meaningful information, the animations may be discarded entirely.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method for improving interactive animation over a computer network having a client and a server, comprising:
a) forming a queue of server messages at the client;
b) adding received server messages to the queue;
c) calculating the minimum deadline of the server messages in the queue;
d) calculating the time required to play all the currently queued animations; and
e) if the time required to play all the currently queued animations is greater than the minimum deadline of the server messages in the queue, accelerating the animation.

2. A method for improving interactive animation over a computer network between first and second clients, comprising:
a) forming a queue of messages from the first client at the second client;
b) adding messages received from the first client to the queue at the second client;
c) calculating the minimum deadline of the messages in the queue;
d) calculating the time required to play all the currently queued animations; and
e) if the time required to play all the currently queued animations is greater than the minimum deadline of the messages in the queue, accelerating the animation.

3. A computer program product for improving interactive animation over a computer network having a client and a server, the computer program product comprising:
a) a computer usable medium having computer readable program code means embodied in the medium for forming a queue of messages from the first client at the second client;
b) the computer usable medium having computer readable program code means embodied in the medium, adding received server messages to the queue;
c) the computer usable medium having computer readable program code means embodied in the medium for calculating the minimum deadline of the server messages in the queue;
d) the computer usable medium having computer readable program code means embodied in the medium for calculating the time required to play all the currently queued animations; and
e) the computer usable medium having computer readable program code means embodied in the medium for determining if the time required to play all the currently queued animations is greater than the minimum deadline of the server messages in the queue, and if it is, accelerating the animation.

4. A computer program product for improving interactive animation over a computer network between a first client and a second client, the computer program product comprising:
a) a computer usable medium having computer readable program code means embodied in the medium for forming a queue of server messages at the client;
b) the computer usable medium having computer readable program code means embodied in the medium, adding received from the first client messages to the queue at the second client;
c) the computer usable medium having computer readable program code means embodied in the medium for calculating the minimum deadline of the messages in the queue;
d) the computer usable medium having computer readable program code means embodied in the medium for calculating the time required to play all the currently queued animations; and
e) the computer usable medium having computer readable program code means embodied in the medium for determining if the time required to play all the currently queued animations is greater than the minimum deadline of the messages in the queue, and if it is, accelerating the animation.
